(19) United States
(12) Patent Application Publication
(10) Pub. No.: US 2021/0099295 A1
(43) Pub. Date: Apr. 1, 2021

(54) METHOD, COMPUTER PROGRAM PRODUCT AND APPARATUS FOR PASSWORD PROTECTED ENCRYPTION KEY RECOVERY

(71) Applicant: Auth9, Inc., Foster City, CA (US)

(72) Inventors: Hongjun Li, Foster City, CA (US); Mayank Jhawar, Indore Madhya Pradesh (IN)

(21) Appl. No.: 17/035,413

(22) Filed: Sep. 28, 2020

Related U.S. Application Data
(60) Provisional application No. 62/907,606, filed on Sep. 28, 2019.

(51) Int. Cl. H04L 9/08; H04L 9/32

(52) U.S. Cl. CPC H04L 9/0863; H04L 9/3226; H04L 9/0894

(57) ABSTRACT

A method, apparatus and computer program product are provided for receiving, from a computing device, a password and at least one recovery element, deriving a password derived encryption key based at least in part on the password, deriving a recovery element derived encryption key based at least in part on the at least one recovery element; encrypting a master encryption key stored in temporary memory using the password derived encryption key to generate a password encryption key cipher for storage in non-transitory memory, encrypting the master encryption key stored in the temporary memory using the recovery element derived encryption key to generate a recovery element encryption key cipher for storage in the non-transitory memory, and upon encrypting the master encryption key using the password derived encryption key and the recovery element derived encryption key, clearing the master encryption key from the temporary memory.

### CROSS-REFERENCE TO RELATED APPLICATIONS

This patent application claims priority from U.S. Provisional Appl. Ser. No. 62/907,606 filed Sep. 28, 2019, all of which are incorporated herein by reference in its entirety.

### FIELD OF THE INVENTION

Embodiments of the present invention generally relate to encrypting and decrypting data, and, more particularly, relate to key generation and applications for using generated keys for various purposes, such as authentication, encryption, and/or other purposes for which keys are useful.

### BACKGROUND OF THE INVENTION

It is common for users to be associated with a large number of log-in, access, encryption, or other password-based credentials for accessing digitally stored data. Given the large number of credentials associated with a particular user, it can be common for users to misplace or forget passwords associated with one or more of these credentials. While certain password-based credentials are managed such that a password may be recovered or reset using recovery procedures, such password-based credentials generally do not provide a high level of security of the underlying protected data. By contrast, password-based encryption keys have historically been impossible to recover and/or reset as the managing systems do not store decryption data that could otherwise be accessible to unauthorized users having nefarious intentions. Thus, once a user misplaces or forgets a password associated with certain password-based encryption keys, the underlying data may be irrecoverable.

Through applied effort and ingenuity, these and other problems with current encryption methodologies have been addressed by certain embodiments discussed herein.

### BRIEF SUMMARY OF THE INVENTION

In general, embodiments of the present invention provided herein include systems, methods, apparatuses, and computer program products for encrypting and decrypting data using cryptographic keys directly from a user's password and a user's recovery element. In some embodiments, an apparatus comprises at least one processor and at least one non-transitory memory storing instructions that, when executed by the processor, configure the apparatus to receive, from a computing device, a password and at least one recovery element, wherein the at least one recovery element represents communication channel information for a user of the computing device, derive a password derived encryption key based at least in part on the password, derive a recovery element derived encryption key based at least in part on the at least one recovery element, encrypt a master encryption key stored in temporary memory using the password derived encryption key to generate a password encryption key cipher for storage in non-transitory memory, encrypt the master encryption key stored in the temporary memory using the recovery element derived encryption key to generate a recovery element encryption key cipher for storage in the non-transitory memory, wherein the master encryption key is utilized for encrypting underlying data, and encrypt the master encryption key stored in the temporary memory using the recovery element derived encryption key to generate a recovery element encryption key cipher for storage in the non-transitory memory, wherein the master encryption key is utilized for encrypting underlying data.

In embodiments, the apparatus is configured to store the password encryption key cipher and the recovery element encryption key cipher in association with a unique ID associated with the user. The at least one recovery element comprising at least one of: an email address, a mobile phone number, a landline phone number, a social media account identifier or a messaging application account identifier. In embodiments, the apparatus is configured to receive, from the computing device, data indicative of the at least one recovery element, utilize a verification instrument associated with the at least one recovery element to establish the user of the computing device as an authenticated user to the master encryption key, and upon verifying the user as the authenticated user, determine the recovery element derived encryption key based at least in part on the recovery element.

In embodiments, the apparatus is configured to determine the recovery element derived encryption key based on the at least one recovery element and decrypt the recovery element encryption key cipher to produce the master encryption key using the recovery element derived encryption key. In embodiments, the apparatus is configured to determine the password derived encryption key based on the password and decrypt the password encryption key cipher to produce the master encryption key using the password derived encryption key.

In embodiments, the apparatus is configured to receive, from the computing device, data indicative of the at least one recovery element and a user identifier, receive a corresponding recovery element encryption key cipher based at least in part on the user identifier, process the at least one recovery element to derive the recovery element derived encryption key, decrypt the corresponding recovery element encryption key cipher to produce the master encryption key using the recovery element derived encryption key, and encrypt the master encryption key using a new password received from the computing device.

Computer program products and computer implemented methods are also configured to implement embodiments of the present disclosure.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram illustrating a system that may benefit from exemplary embodiments of the present invention;

FIG. 2 illustrates a block diagram of a server that may be configured in accordance with an example embodiment of the present disclosure;

FIG. 3 illustrates a block diagram of a user computing entity that may be configured in accordance with an example embodiment of the present disclosure;

FIG. 4 is a block diagram illustrating password based key generation that may benefit from exemplary embodiments of the present invention;

FIGS. 5A, 5B, and 5C are block diagrams illustrating example processes for encrypting a master encryption key using a password or a recovery element, and storing key ciphers in accordance with exemplary embodiments of the present invention;

FIG. 5D is a block diagram illustrating an example process of changing a password in perspective of decrypting and encrypting a master encryption key in accordance with exemplary embodiments of the present invention; and

FIGS. 6-9 illustrate flowcharts depicting various operations performed in accordance with an example embodiment of the present disclosure.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

### I. Overview

Various embodiments provide data encryption methodologies enabling processes for recovering password protected encryption keys, for example, when an associated user loses his password. In this case, the master encryption key is encrypted using a user's password and a user's recovery element (e.g., data indicative of, or accessible via, an email address, a phone number, and/or the like). Such embodiments enable recovery of the master encryption key via the user's recovery element in instances in which the user does not have access to the password utilized to encrypt the master encryption key. Various embodiments provide for utilizing an encryption algorithm which derives cryptographic keys directly from a user's password and a user's recovery element, and then utilizes the derived cryptographic keys (e.g., password derived encryption key and recovery element derived encryption key) to encrypt the master encryption key to produce a password encryption key cipher and a recovery element encryption key cipher. These two ciphers are stored to the server and are independently capable of decrypting the master encryption key (thereby enabling decryption of the underlying stored data) based on the provided password (used in combination with the password encryption key cipher) or recovery element (used in combination with the recovery element encryption key cipher), without requiring storage of the user's password. Accordingly, such embodiments enable recovery of a master encryption key via a user's recovery element, without exposing the underlying encrypted data to security vulnerabilities associated with typical password recovery mechanisms. Moreover, utilizing a recovery element as discussed herein enables additional security, such as through multi-factor authentication. Utilizing multi-factor authentication prior to decrypting a master encryption key with a recovery element encryption key cipher comprises, for example, sending a verification code to a user computing entity associated with the user, such as by sending a verification code to the user's phone by text message, the user's email address, or the user's special-purpose client application (e.g., WeChat, WhatsApp), or the like and verifying this code before authentication. Once the multi-factor authentication process is complete, the recovery element may be utilized with the recovery element encryption key cipher to recover the master encryption key, thereby enabling access to the underlying data. The master encryption key may then be reset, for example by discarding the master encryption key to generate a new master encryption key together with a new password (and password encryption key cipher) and a new recovery element (and recovery element encryption key cipher).

### II. Computer Program Products, Methods, and Computing Entities

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, user computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, field programmable gate array, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

### III. Exemplary System Architecture

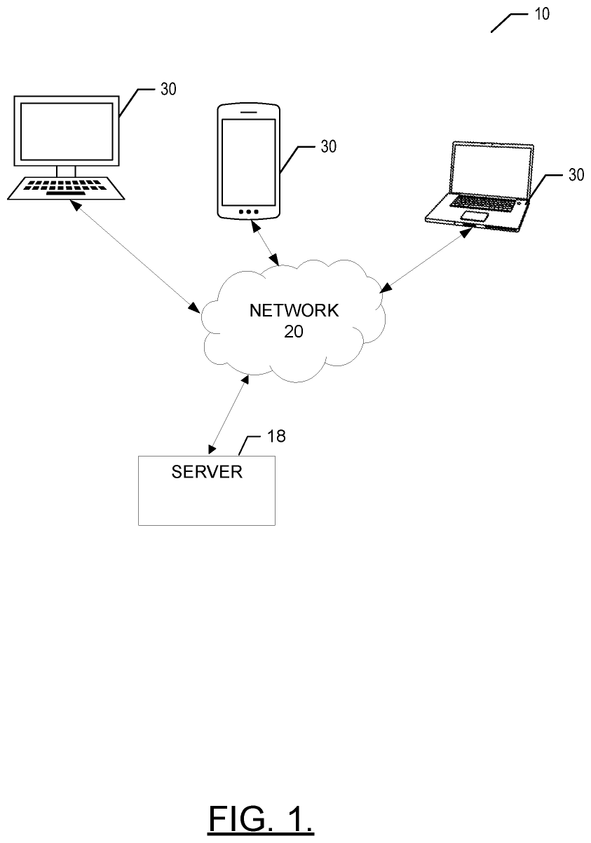

FIG. 1 is a basic block diagram illustrating a system 10 that may benefit from exemplary embodiments of the present invention. As shown and described herein, the system 10 could be employed in the context of a network 20 over which numerous electronic devices may communicate via wired, wireless or a combination of wired and wireless communication mechanisms. In an exemplary embodiment, the electronic devices or user computing entities 30 may be embodied as personal computers (PCs) or other terminals that may enable individuals to run applications and/or communicate with each other in accordance with embodiments of the present invention. The network 20 may be any of a number of different communication backbones or frameworks including, for example, the Internet, a local area network (LAN), a personal area network (PAN), a campus area network (CAN), a metropolitan area network (MAN), or the like. In one exemplary embodiment, the server 18 could be part of a LAN or other localized network (e.g., associated with a particular company) and the server 18 may be in communication with the network 20 either directly or via a gateway device of the LAN.

a. Exemplary Server

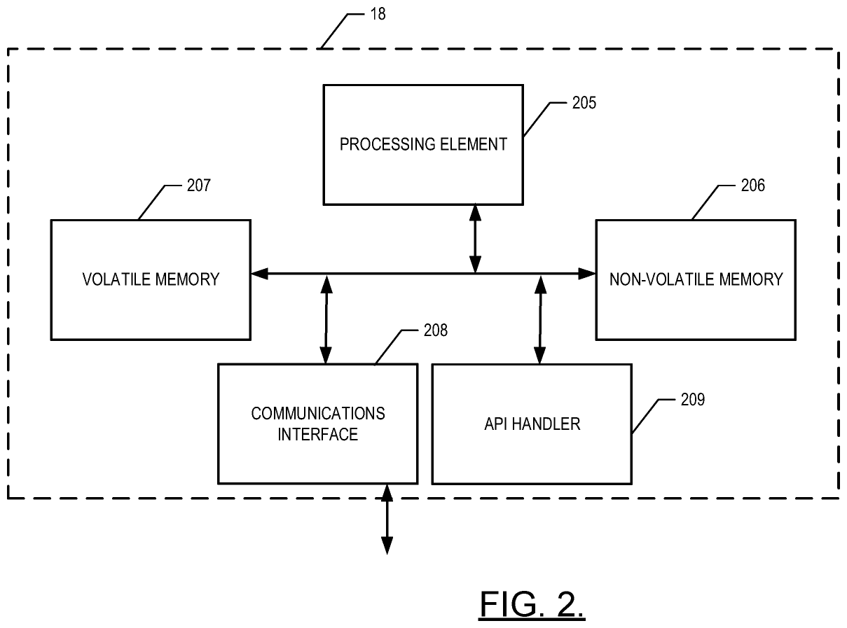

The server 18 may be a server or other computing platform including memory and processing capability (e.g., the volatile memory 207, the application programming interface (API) handler 209, and the processing element 205 of FIG. 2) and in communication with the network 20 in order to facilitate operation in accordance with embodiments of the present invention. In some embodiments, the server 18 may host a verification app providing access to the functionalities, devices and/or elements described in connection with the server 18 below.

According to one embodiment, the server 18 includes API handler 209 which is operable to handle a plurality of different API calls for registration, login, or password reset. For example, the server 18 may provide an API for authentication services that, when used by user computing entity may implement a registration and login procedure that captures and verifies a user's password and/or one or more recovery elements. A user computing entity may integrate such APIs into their systems. In some embodiments, the server 18 provides an API call for master encryption key production (thereby enabling decryption of underlying stored data) that implements a key recovery procedure. The master encryption key production API call may be useful for users who may have forgotten their password in a conventional username-password authentication process. For example, the master encryption key production API call may implement the key recovery procedure for helping the user obtain the master encryption based on one or more recovery elements. The one or more recovery elements representing communication channel information for a user of the computing device. In an example embodiment, the user may enter the user's email address in a user interface. In response, the master encryption key production API may generate a one-time passcode which, for example, may be a personal identification number (PIN) or a random string of upper case and lower case characters, numbers, and special characters used to authenticate the user. The one-time passcode is transmitted in an e-mail message to the user's email address. The user would then enter the one-time passcode back in the user interface. Once the user is authenticated by the server 18, the master encryption key may be obtained. Additionally, once the master encryption key is obtained, the user may change their password.

FIG. 2 provides a schematic of a server 18 according to one embodiment of the present invention. In general, the terms computing entity, user computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the server 18 may communicate with other analytic computing entities, one or more user computing entities 30, and/or the like.

As shown in FIG. 2, in one embodiment, the server 18 may include or be in communication with one or more processing element 205 (also referred to as processors, processing circuitry, and/or similar terms used herein interchangeably) that communicate with other elements within the server 18 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the server 18 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 206 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Non-volatile storage or memory media 206 may also be embodied as a data storage device or devices, as a separate database server or servers (as shown in FIG. 1), or as a combination of data storage devices and separate database servers. Further, in some embodiments, non-volatile memory 206 may be embodied as a distributed repository such that some of the stored information/data is stored centrally in a location within the system and other information/data is stored in one or more remote locations. Alternatively, in some embodiments, the distributed repository may be distributed over a plurality of remote storage locations only.

Non-volatile memory 206 may include information/data accessed and stored by the server 18 to facilitate the operations of the server 18. More specifically, non-volatile memory 206 may encompass one or more data stores configured to store information/data usable in certain embodiments.

In one embodiment, the server 18 may further include or be in communication with volatile media (also referred to as volatile storage, memory, memory storage, memory circuitry and/or similar terms used herein interchangeably). In one embodiment, the volatile storage or memory may also include one or more volatile storage or memory media 207 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 308. Thus, the databases, database instances, database management system entities, data, applications, programs, program modules, scripts, source code, object code, byte code, compiled code, interpreted code, machine code, executable instructions, and/or the like may be used to control certain aspects of the operation of the server 18 with the assistance of the processing element 205 and operating system.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the server 18 may communicate with computing entities or communication interfaces of other servers, terminals (e.g., user computing entities 30), and/or the like.

As indicated, in one embodiment, the server 18 may also include one or more network and/or communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the server 18 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The server 18 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the user computing entity's components may be located remotely from other server components, such as in a distributed system. Furthermore, one or more of the components may be aggregated and additional components performing functions described herein may be included in the server 18. Thus, the server 18 can be adapted to accommodate a variety of needs and circumstances.

b. Exemplary User Computing Entity

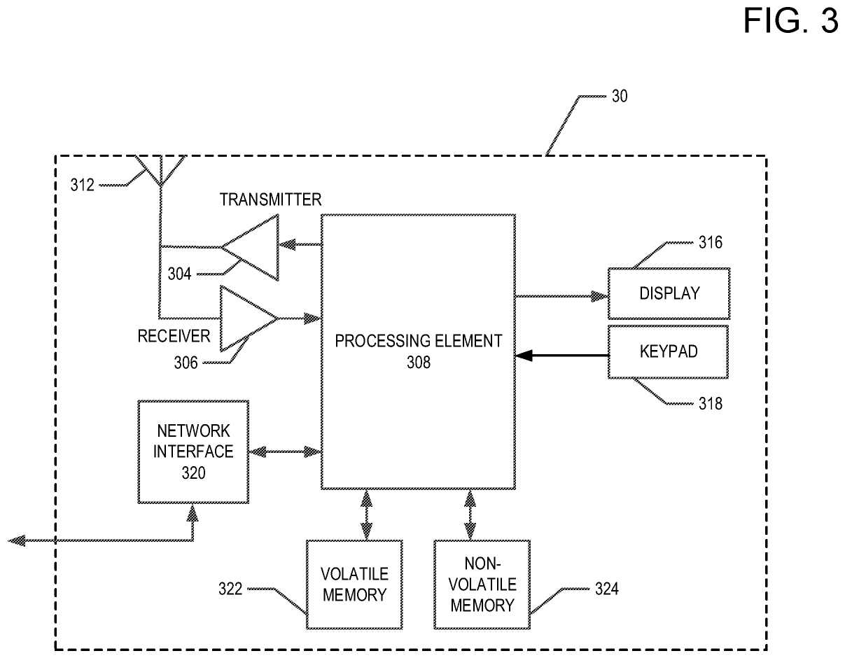

FIG. 3 provides an illustrative schematic representative of user computing entity 30 that can be used in conjunction with embodiments of the present invention. As will be recognized, the user computing entity may be operated by a user and include components and features similar to those described in conjunction with the server 18. Further, as shown in FIG. 3, the user computing entity may include additional components and features. For example, the user computing entity 30 can include an antenna 312, a transmitter 304 (e.g., radio), a receiver 306 (e.g., radio), a network interface 320, and a processing element 308 that provides signals to and receives signals from the transmitter 304 and receiver 306, respectively and/or the network interface 320. The signals provided to and received from the transmitter 304 and the receiver 306, respectively, may include signaling information/data in accordance with an air interface standard of applicable wireless systems to communicate with various entities, such as server 18, another user computing entity 30, and/or the like. In this regard, the user computing entity 30 may be capable of operating with one or more air interface standards, communication protocols, modulation types, and access types. More particularly, the user computing entity 30 may operate in accordance with any of a number of wired or wireless communication standards and protocols. In a particular embodiment, the user computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the user computing entity 30 can communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 30 can also download changes, add-ons, and updates, for instance, to its firmware, software (e.g., including executable instructions, applications, program modules), and operating system.

According to one embodiment, the user computing entity 30 may include location determining aspects, devices, modules, functionalities, and/or similar words used herein interchangeably. For example, the user computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including low earth orbit (LEO) satellite systems, DOD satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the user computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the user computing entity 30 to cause display or audible presentation of information/data and for user interaction therewith via one or more user input interfaces. The user output interface may be updated dynamically from communication with the server 18. The user input interface can comprise any of a number of devices allowing the user computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user computing entity 30 can collect information/data, user interaction/input, and/or the like.

The user computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user computing entity 30.

c. Exemplary Server Modules

In various embodiments, the server 18 comprises one or more data stores, which may store data such as encrypted underlying data, encryption data, and data owner information. The encrypted private data may encompass encrypted private data protected through the encryption methodology (e.g., a data object, a data file, a collection of data files, and/or the like). The encryption data may comprise an encrypted master encryption key (e.g., password encryption key cipher or recovery element encryption key cipher), wherein the master encryption key may be used for decrypting the encrypted private data. The data owner information may comprise one or more user data elements such as a unique user identifier (e.g., a random string such as “123a4b56c789d”—that represents the user's account registered with the server 18 and/or social media account or messaging application account), a hash of one or more recovery elements, and/or other user (or private data) identifying data. Such data may be associated within the storage thereby enabling alternative access to the private data through various decryption methodologies as discussed herein. Other unique identifiers may be utilized in certain embodiments, such as unique identifiers corresponding with a private data object encrypted as discussed herein, and/or the like. As discussed herein, the unique user identifier may be stored together with a password derived encryption key cipher. The password derived encryption key cipher corresponds with a password that is not stored in memory but may be remembered by the user, such that upon receipt of user input indicative of the user name and password, the server 18 retrieves the appropriate password derived encryption key cipher (based on the user name), and combines the user input password with the password derived encryption key cipher to generate a password derived encryption key.

However, in the event the user is unable to remember his/her password, the user may retain access to the private encrypted data via one or more recovery elements (e.g., an email address, a user's mobile number and one-time passcode received from the server 18 in order to login to a service provider's system or website). In some embodiments, the server 18 may optionally store one or more recovery element hashes for verification of a recovery element presented by a user as user input (e.g., cryptographic hash of a recovery element, which in an example case is a mobile number of the user) prior to use of the recovery element to decrypt the master encryption key. Accordingly, a recovery element derived encryption key cipher may additionally be stored in association with the user name and/or password derived encryption key cipher to enable decryption of the master encryption key. In this regard, the recovery element represents communication channel information for a user of the user computing entity/device.

As discussed, the server 18 may store encryption data that may be utilized to recover encryption keys—which may be embodied as a master encryption key (encrypting private data), a password derived encryption key (encrypting the master encryption key), and/or a recovery element derived encryption key (encrypting the master encryption key). Each of the encryption keys may include digital information (e.g., data structure; one or more items of data; and the like) that determines the functional output of a cryptographic algorithm. An encryption key specifies the transformation of private data plaintext (or other plaintext) into private data ciphertext (or other ciphertext), and/or in reverse to transform the encrypted data (private data ciphertext or other ciphertext) into decrypted data (private data plaintext or other plaintext). The private data plaintext may include text, binary data, messages, application data, or any other type of data. In an example embodiment, the encryption key is a cryptography random number (e.g., 256-bit key). Encryption data includes a key hierarchy that provides an organizational structure for the encryption keys (e.g., which may be stored in reference to the stored encryption key ciphers, as the underlying encryption keys are not stored) so that a master encryption key is used to encrypt the private data and a password derived encryption key is used to encrypt the master encryption key to produce a password encryption key cipher.

Additionally, the key hierarchy is indicative of a recovery element derived encryption key used to encrypt the master encryption key to produce a recovery element encryption key cipher (specifically, the recovery element encryption key cipher may be stored in association with the key hierarchy). Either one of the password derived encryption key or the recovery element derived encryption key or both may increase required time to brute force attack encrypted private data or content associated with the master encryption key. In this case, the server 18 stores password encryption key cipher and the recovery element encryption key cipher; and the user knows the password and is authenticated via at least one recovery element. Therefore, a security breach at either the server 18 or the user's computing entity 30 does not jeopardize the master encryption key, even to standard brute force attack. Further, it would be difficult to compute the derivative of the password (password derived encryption key) and/or the recovery element (recovery element derived encryption key). Even if a brute force attacker guessed the password or is able to be authenticated via at least one recovery element (e.g., attacker is able to login to user's social media account), and thus obtain the password derived encryption key or the recovery element derived encryption key, the brute force attacker would have no way of producing the master encryption key without having the password encryption key cipher and the recovery element encryption key cipher.

In embodiments, the master encryption key is a randomly generated sequence of bits, which is used as a key to encrypt and decrypt electronic data. The master encryption key may remain constant (i.e., never needs to change) if it is protected, such as through a hierarchical nature of a plurality of encryption keys within the key hierarchy, such that the master encryption key is never directly accessed by a user. For example, if the master encryption key is accessed only indirectly by users (without the users ever directly provided with access to the master encryption key), such as through a process for accessing the master encryption key utilizing a password derived encryption key and/or a recovery element derived encryption key, the master encryption key need not be provided to a user, the user's device, or to any storage location (whether permanent or temporary) that would expose the master encryption key to potential privacy attacks. However, by utilizing a plurality of mechanisms for accessing the master encryption key, the configuration as discussed herein enables users to recover forgotten passwords without losing access to their encrypted private data. When the user forgets their password, the master encryption key may be recovered using the recovery element derived encryption key. When the user wants to change their password, then the master encryption key is re-encrypted with a new password derived encryption key.

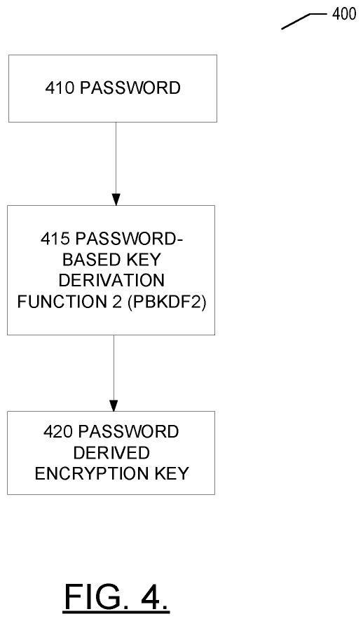

In an example embodiment, encrypted private data is stored in the one or more data stores. The password is not stored at the server 18, and is known by an authorized party (e.g., authorized data owners and/or data users). Similarly, encryption keys are not stored in the one or more data stores, however certain encryption key ciphers are stored in association the encrypted private data, and those encryption key ciphers may be combined with corresponding data generated based at least in part on user input (e.g., a user-input password or a user-input recovery element) to provide an encryption key. Hence, unauthorized users are unable to hack into a password storage data store to retrieve user passwords through unauthorized methodologies, and only the owner having knowledge of the password has access to the encrypted data via a typical password entry approach. Data encryption can be performed at the user computing entity 30 (such that the server 18 is never exposed to unencrypted private data), or at the server 18. In an example embodiment, the server 18 may operate with an encryption scheme using a password derivation function. FIG. 4 illustrates a procedure related to generating a derived, or combined, key (e.g. password derived encryption key). A password 410 such as a password or sequence of numbers to unlock a device is combined with a random salt value (not pictured) via the password-based key derivation function 2 (PBKDF2) 415 or some other suitable algorithm. In this regard, PBKDF2 uses the password 410, a known value (e.g., salt) and a predetermined number of iterations (e.g., 10,000 iterations) to perform as input and produce a password derived encryption key 420. PBKDF2 yields a combined, or derived, password derived key 420 which is used to encrypt a master encryption key which is used to encrypt the private data. During the decryption process, password 410 is used to derive the password derived key 420, which in turn is used to obtain a master encryption key (e.g., to store the master encryption key in temporary memory at the server, without access by the user) which is used to decrypt the private data.

The server 18 is configured to manage encryption keys and to enforce permission policies, such as by restricting access to certain private data to only authorized users. For example, the server 18 is configured to authenticate a data owner and/or data user prior to cryptographic processing of data. In an example embodiment, the server 18 is configured to implement one or more authentication methods such as, but not limited to, one-time passwords or passphrases or one or more password recovery element methodologies which will be described in detail below.

In some embodiments, the server 18 stores some derivation of the one or more recovery elements that may be utilized for verification of the recovery element without requiring storage of the recovery element itself, for example a recovery element hash. In an example embodiment, the server 18 accepts one or more recovery elements provided during an initial process for establishing a recovery element encryption key and recovery element encryption key hash, generates a hash value of the provided recovery element (e.g., utilizing a hashing algorithm) and stores the resulting hash value for later reference. The initially provided recovery element is not needed for storage, thereby minimizing opportunities for unauthorized access to data that may be utilized for retrieving the master encryption key. For example, a user's email address or telephone number may be provided as a recovery element (communication channel information). The server 18 may then generate a hash of the provided email address and/or telephone number, and the resulting hash value may be stored at the server. Thereafter, during a recovery element based decryption process, the server receives a user's email address or telephone number as an alleged recovery element, the server then compares the entered user's email address or telephone number with the hash stored on server 18 (e.g., by hashing the user input and comparing the resulting hash value with the stored hash value at the server 18). While the comparison process is undertaken, the server 18 may store the user input in temporary memory, such that the recovery element may be utilized for contacting the user if the recovery element is determined to match the stored hash. If the hash values match, the server generates a one-time passcode/verification code to be transmitted to the user via the contact information utilized as the recovery element, thereby utilizing the recovery element as a multi-factor authentication for providing access to the encrypted private data (via the master encryption key). The user receives the one-time passcode (e.g., within an automatically generated email sent to the user's email address, within an SMS message sent to the user's mobile phone number, and/or the like), and provides the same one-time passcode to the server 18 as user input to a graphical user interface presented to the user when requesting decryption of the underlying data via the recovery-element based decryption methodology. The server 18 compares the one-time passcode received from the user against the one-time passcode 18 transmitted to the user (or a hash thereof). Upon determining a match, the server 18 utilizes the recovery element together with the recovery element encryption key cipher to generate the master encryption key which is used to decrypt the data. As described in further detail below, the server 18 may be configured to provide at least one recovery element that may be easier to use. For example, users will most likely remember their phone number and email address. Most users have setup third-party systems (such as Facebook®, Twitter®, LinkedIn®, or other social media account or messaging application account such as WeChat, WhatsApp, or other messaging application account) for automatic login. Thus, utilizing at least one recovery element that is easily remembered or instantly accessible by users alleviates difficulties with remembering passwords, which are often forgotten. As discloses herein, the server 18 may be configured to perform user authentication using several different recovery elements or communication channels, such as email, mobile phone, SMS, third party systems, social media accounts, or other authorization mechanisms in order to complete the process (e.g. email asking user to confirm server generated passcode or confirm user).

In another example, a recovery element may be embodied as, or may comprise contact information (communication channel information) usable for contacting the user via a third party system (such as Facebook®, Twitter®, LinkedIn®, WeChat, WhatsApp, or other social media account or messaging application account). As discussed, the server 18 does not directly store the recovery element in non-transitory memory, and accordingly the server 18 may be configured to request user input indicative of a recovery element (e.g., via a graphical user interface presented to a user via a computing device) when performing a process for utilizing a recovery element to decrypt a master encryption key. Moreover, because the contact information alone may not be unique (e.g., a text string indicated as a Facebook user name may also be indicated as a LinkedIn user name), the server 18 may additionally request that the user provide data indicative of the third party system applicable to the user name. Moreover, in such embodiments, the recovery element hash that may be stored at the server 18 may be a hashed representation of a combination (e.g., a concatenated string) comprising the user name and an indicator representative of the applicable third party system. As a non-limiting example, the hash corresponding with a Facebook username of “BobSmith1234” may be a hashed representation of the string “BobSmith1234$Facebook”. It should be understood that the unique indicator corresponding with a particular third party system need not be a human-readable indication of the system, and instead may be a randomized character string that may be correlated with the third party system by the server 18. In this case, the server 18 may include a hash generator configured to execute a number of secure hash algorithms (e.g., SHA-1, SHA-2, or SHA-3, MD5, etc.). When contact information associated with a third party system is utilized as a recovery element, the server 18 may be configured to generate a one-time use passcode and to transmit the one-time use passcode to the user via the third party system (utilizing the user-provided username) after verification that the username matches the hash of the recovery element. In such embodiments, the server 18 may have a corresponding registered account with the third party system to enable the server 18 to transmit messages via the third party system

In another example embodiment, server 18 may provide another mechanism to request user input indicative of a recovery element (e.g., via a graphical user interface presented to a user via a computing device) when performing a process for utilizing a recovery element to decrypt a master encryption key. In the course of registering an account with the server 18, the server is configured to request answers to a collection of personal questions (e.g., What is your driver's license number, what is your passport number, or what is your favorite dish?). In another example embodiment, the user may provide both the questions and answers. The answers and/or questions may be stored to server 18 in a hashed form. For example, the server 18 is configured to launch a graphical user interface to retrieve the list of personal questions and then request from the user via a computing device to answer one or more of the personal questions. The answers are compared with the stored hashed answers. When there is a match, the server 18 provides authorization to generate the one-time passcode and to transmit the one-time use passcode to the user via the graphical user interface, a user-provided phone number, or user-provided email address.

d. Exemplary Networks

In one embodiment, the networks 20 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 20 may have any suitable communication range associated therewith and may include, for example, global networks (e.g., the Internet), MANs, WANs, LANs, or PANs. In addition, the networks 20 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### IV. Exemplary System Operation

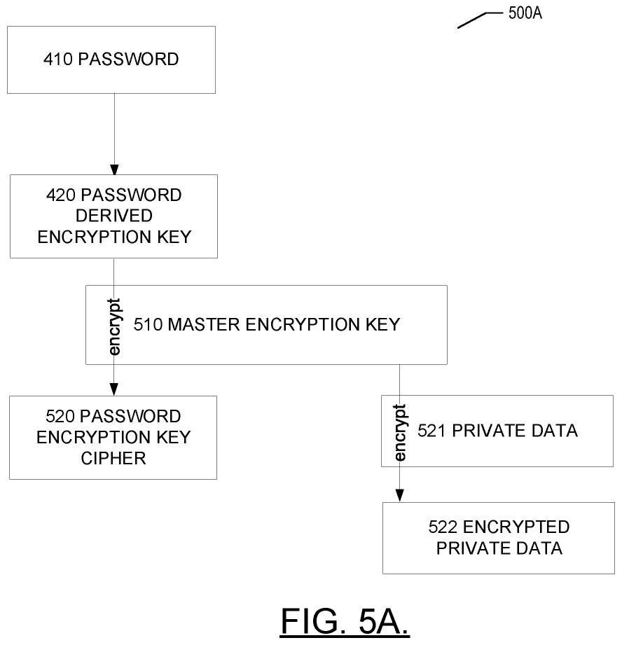

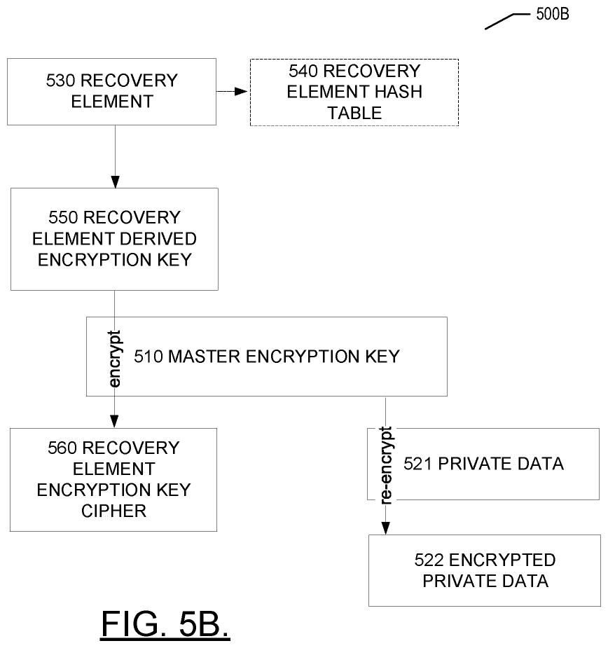

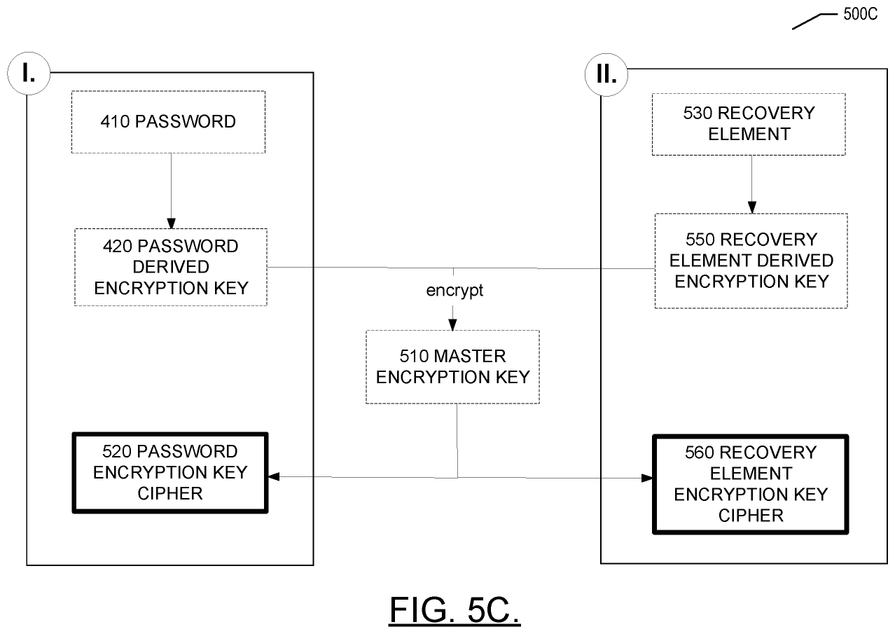

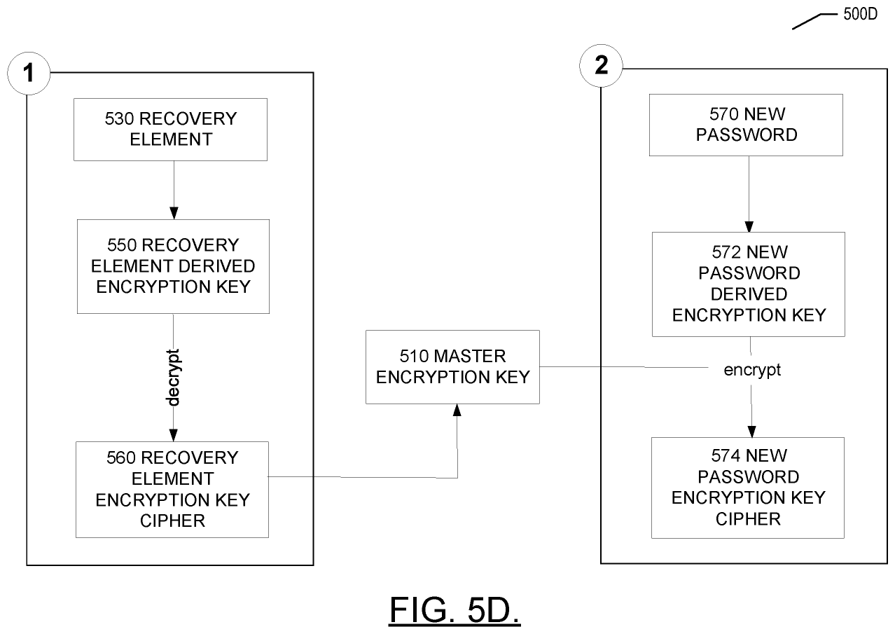

Reference will now be made to FIGS. 5A-5D, which illustrates various functionalities performed by the computing entities discussed herein. Certain embodiments as discussed herein utilize public-key cryptography, symmetric encryption (e.g., Advanced Encryption Standard (AES), and cryptographic hashing (e.g., SHA-256 or PBKDF2) for certain aspects discussed herein. It should be understood that in certain embodiments, other encryption methodologies may be utilized. Public-key cryptography may be utilized for key generation and data encryption as well as generating digital signatures and/or for authentication. Public-key encryption and/or digital signature schemes may be used include, without limitation, Rivest-Shamir-Adelman (RSA), Elliptic Curve, Quantum Safe algorithms, and/or the like. Encryption strength may be selected based at least in part on the selected encryption scheme and/or security requirements utilized.

a. Generation of Master Encryption Key

In some embodiments, private data is protected by encryption, and the server 18 using the user's password and/or at least one recovery element decrypts the encrypted private data. For example, the private data 521 of FIG. 5A is encrypted using the master encryption key 510. The master encryption key 510 may be a randomly generated sequence of bits, which is used as a key to encrypt and decrypt the private data 521 by using an encryption algorithm. In some embodiments, the master encryption key 510 used to encrypt private data 521 is unique. In another embodiment, the master encryption key 510 is used to encrypt/decrypt other encryption keys. In this case the other encryption keys are used to encrypt/decrypt the private data 521. Only the users themselves can derive the master encryption key 510. In other words, only those persons with access to the user's password 410 and/or recovery element can access the master encryption key 510. In order to protect the private data encrypted by the master encryption key (encrypted private data 522), the master encryption key 510 is also encrypted. In some embodiments, the server 18 generates the master encryption key 510, encrypts the private data 521 with the master encryption key 510, and saves the encrypted private data 522 in non-transitory memory. The server 18 is then configured to encrypt the master encryption key 510 with a password derived master key 420 from the password 410 to produce the password encryption key cipher 520. At this point, the server 18 may save the password encryption key cipher 520 in non-transitory memory and discard or destroy the master encryption key 510. In order to decrypt the encrypted private data 522, the server 118 obtains (or receives from the user) the password 410 which is used to generate the password derived encryption key 420. The password derived master key 420 is used to obtain the master encryption key 510 which is used to decrypt the encrypted private data 522.

In another example embodiment, the server 18 may not generate the master encryption key 510 nor encrypt the private data 521 with the master encryption key 510. In some embodiments, the server 18 does not save the encrypted private data 522 in non-transitory memory. In this regard, some entity may generate the master encryption key 510, encrypt the private data 521 using the master encryption key 510, and store the encrypted private data 522. The server 18 may be configured to, using a secure communications channel, receive the master encryption key 510, albeit temporarily, in order to generate the password encryption key cipher 520. For example, after receiving the master encryption key 510 from the entity, the server 18 is configured to encrypt the master encryption key 510 with a password derived encryption key 420 to generate the password encryption key cipher 520. The password derived encryption key 420 is generated from the password 410. The server 18 may save the password encryption key cipher 520 in non-transitory memory and discard or destroy the master encryption key 510. In order to decrypt the encrypted private data 522, the server 118 obtains (or receives from the user) the password 410 which is used to generate the password derived encryption key 420. The password derived master key 420 is used to obtain the master encryption key 510 which is used to decrypt the encrypted private data 522. In these cases, the server 18 only stores the encrypted form of the master key (e.g., password encryption key cipher 520) which may be decrypted using the password 410.

b. Generation of a Password Encryption Key Cipher and a Recovery Element Encryption Key Cipher

Various embodiments provide for a master-level encryption of private data. The private data as discussed herein may comprise one or more data objects, one or more data files, one or more data files sets, one or more portions of a data file, and/or the like. The master-level encryption of certain embodiments utilizes a master encryption key to encrypt the private data. The master encryption key may be symmetric (e.g., only one secret key or master encryption key to cipher and decipher data) or asymmetric (e.g., in combination with a master private/public key pair or two different keys to encrypt and decrypt data). At least a portion of encryption data associated with the master encryption key (e.g., the master encryption key itself) may itself be encrypted, such that the master encryption key itself need not be stored within a memory storage area after initial creation of the master encryption key and corresponding password derived encryption key and recovery element derived encryption key. The password derived encryption key and the recovery element derived encryption key may each be independently usable (with corresponding key ciphers stored within non-transitory memory) to recover the master encryption key, thereby enabling decryption of the underlying private data. In certain embodiments, neither the password derived encryption key, nor the recovery element derived encryption key is stored in non-transitory memory after generation of the corresponding encryption key ciphers. Accordingly, the non-transitory memory does not contain sufficient stored data to enable decryption of the underlying private data, thereby providing high levels of security against unauthorized access to the underlying private data. In one embodiment, the server 18 is configured to encrypt private data with a master encryption key to provide a master-level encryption. This master-level encryption key is itself encrypted via at least two independently usable encryption methodologies, each of which may be utilized independently to obtain the master encryption key through decryption. For example, the server 18 is configured to encrypt the master encryption key with a password level of protection and a recovery element level of protection. The server 18 is configured to create a password level of encryption, the password level of encryption comprising a password derived encryption key and password encryption key cipher. The server may store the password encryption key cipher in non-transitory memory and discard or destroy the master encryption key. To decrypt the private data utilizing the password derived encryption key, the server 18 receives from the user, via a computing device, the password to obtain the password derived encryption key. Once the password derived encryption key is obtained, the server is configured to decrypt the password encryption key cipher using the password derived encryption key to produce the master encryption key. The master encryption key is used to decrypt the underlying encrypted private data. Additionally, the server 18 is configured to create a recovery element level of encryption, the recovery element level of encryption comprises a recovery element derived encryption key and recovery element encryption key cipher. The server may store the recovery element encryption key cipher in non-transitory memory and discard or destroy the master encryption key. To decrypt the private data, the server 18 is configured to receive from the user, via a user computing device, at least one recovery element associated with the recovery element derived encryption key. In this regard, the server may generate the recovery element derived encryption key from the at least one recovery element. The server 18 may then proceed to decrypt the recovery element encryption key cipher to obtain the master encryption key which is then used to decrypt the encrypted private data. As such, the server 18 is configured to utilize the master encryption key to encrypt and decrypt private data. The master encryption key is encrypted with the password derived encryption key and/or the recovery element derived encryption key.

FIG. 5A illustrates an exemplary block diagram 500A of an example process for generating a password encryption key cipher. In some embodiments, the user computing entity 30 transmits an encryption request to the server 18 to encrypt private data that the user computing device will transmit over network 20, such as the internet. For example, the server 18 may be configured to output a login interface to a display interface (i.e., a graphical user interface) of a user computing entity with at least options to encrypt or decrypt data. A user may login and choose to encrypt data by transmitting the encryption request. The encryption request includes a user identifier (e.g., user name, an internet protocol (IP) address, a media access control (MAC) address, and the like) and a password 410 as inputted by the user. Server 18 receives the user identifier and password 410, generates a random salt value (e.g., random 128 bit value) that corresponds to the user identifier. The server 18 is then configured to utilize the password 410 and the random salt value and run one or more rounds, or iterations, of PBKDF2, thereby producing a password derived encryption key 420. As such, dictionary attacks against the password derived encryption key 420 are unfeasible. In some embodiments, PBKDF2 applies a pseudorandom function (PRF) to the password 410 a predetermined number of times. The PRF may include a cryptographic hash, cipher, or hash-based message authentication code (HMAC) to the password 410 along with the random salt value repeated a predetermined number of times to produce the password derived encryption key 420, which can then be used to encrypt the master encryption key. The random salt value acts as a parameter making each derived key operation unique. In some embodiments, the server 18 may be configured to determine the following PBKDF2 input parameters: HMAC, the password (bytes sequence), the random salt value (bytes sequence), iterations count and the output key length (number of bytes for the password derived encryption key 420). Alternatively, the user via the user computing device may provide the PBKDF2 input parameters. In this case, the server 18 receives PBKDF2 input parameters from a user interface (e.g., via a graphical user interface presented to a user via a computing device). The server 18 is then configured to encrypt a master encryption key 510 with the password derived encryption key 420. In some embodiments, the server 18 is configured to generate the master encryption key 510. The server 18 encrypts the private data 521 with the master encryption key 510, and saves the encrypted private data 522 in non-transitory memory. In some embodiments, the server 18 may generate for display via the display interface a confirmation modal window confirming that the user's private data is encrypted. The server 18 is then configured to use the password derived encryption key 420 to encrypt the master encryption key 510 to produce a password encryption key cipher 520 that is stored to the server 18. For example, the server 18 may store in non-transitory memory an entry comprising the user identifier, the random salt value, and the password encryption key cipher. In some embodiments, the master encryption key 510 and the password derived encryption key 420 are temporarily stored in transitory memory during generation of the password encryption key cipher 520. To further prevent unauthorized attacks, the server 18 is configured to disconnect from network connectivity during generation of the password encryption key cipher 520. Once the password encryption key cipher 520 is generated and the recovery element encryption key cipher 560 is generated as discussed below, the server 18 may discard or destroy the master encryption key 510, the password derived encryption key 420, and the recovery element derived encryption key 550. In this case, the transitory memory of the server 18 is further cleared in a manner that no artefacts of the master encryption key 510, the password derived encryption key 420, the recovery element derived encryption key 550, the recovery element 530, and the password 410 are recoverable from memory. As such and in one embodiment, the password 410 is used to determine the password derived encryption key 420 to decrypt the password encryption key cipher 520 and therefore obtain the master encryption key 510. In this regard, brute force attacks are prevented, as the brute force attacker must know the password 410 to perform a brute force attack on the server 18.

FIG. 5B illustrates an exemplary block diagram 500B of an example process for generating a recovery element encryption key cipher. In some embodiments, the user computing entity 30 transmits an encryption request to the server 18 to re-encrypt the private data 521. In this case, since the password 410 was not directly tied to the encrypted private data 522 (i.e., the password 410 was not used to encrypt private data 521 to produce encrypted private data 522), the server 18 does not need to decrypt and re-encrypt all of the private and instead the server 18 may be configured to re-encrypt the master encryption key 510 with a recovery element derived encryption key 550 as discussed herein. For example, the server 18 may be configured to output a login interface to a display interface (i.e., a graphical user interface) of a user computing entity with at least options to encrypt (re-encrypt) or decrypt data. A user may login and choose to re-encrypt data by transmitting the encryption request. The encryption request includes a user identifier (e.g., user name, an internet protocol (IP) address, a media access control (MAC) address, and the like) and a password 410 as inputted by the user. Server 18 receives the user identifier and password 410, accesses the random salt value that corresponds to the user identifier, and utilizes the password 410 and the random salt value to determine the password derived encryption key 420 which is used to decrypt the master encryption key 510. The master encryption key 510 is ready to be re-encrypted using at least one recovery element 530. In this regard, the server 18 may be configured to output a recovery element interface to a display interface (i.e., a graphical user interface) of a user computing entity with at least options to select one or more recovery elements from a plurality of recovery elements, wherein each of the one or more recovery element represents communication channel information for a user of the computing device. For example, in various embodiments, each of the plurality of recovery elements are configured to trigger execution of recovery element-level user authentication (e.g., sending a verification code to a user computing entity associated with the user, such as by sending a verification code to the user's phone by text message, the user's email address, the user's special-purpose client application (e.g., Facebook®, LinkedIn®, Twitter), or the like and verifying this code before authentication).

In another example embodiment, the server is configured to request answers to a collection of personal questions (e.g., What is your driver's license number, what is your passport number, or what is your favorite dish?) to which the user may provide the answers. The server 18 may compare the received answers with the stored hashed answers. When there is a match, the server 18 provides authorization to generate the one-time passcode and to transmit the one-time use passcode to the user via the graphical user interface, a user-provided phone number, or user-provided email address.

Once the server 18 authenticates the user with at least one of the recovery elements, the server 18 is then configured to utilize the recovery element 530 and a random salt value and run one or more rounds, or iterations, of PBKDF2, thereby producing a recovery element derived encryption key 550. In some embodiments, the server 18 may create a cryptographic hash value for the recovery element 530. As an additional option, also illustrated by dashed lines, the cryptographic hash value of the recovery element 530 can be stored by the server 18 in non-transitory memory in a recovery element hash table 540. Returning now to operations subsequent to the generation of the recovery element derived encryption key 550, the server 18 is then configured to re-encrypt the master encryption key 510 with the recovery element derived encryption key 550. In some embodiments, the server 18 may generate for display via the display interface a confirmation modal window confirming that the master encryption key 510 has been re-encrypted using the recovery element derived encryption key 550. The server 18 is then configured to use the recovery element derived encryption key 550 to encrypt the master encryption key 510 to produce a recovery element encryption key cipher 560 that is stored to the server 18 in non-transitory memory. For example, the server 18 may store in non-transitory memory an entry comprising the user identifier, the random salt value, and the recovery element encryption key cipher 560. In some embodiments, the master encryption key 510 and the recovery element derived encryption key 550 are temporarily stored in transitory memory during generation of the recovery element encryption key cipher 560. To further prevent unauthorized attacks, the server 18 is configured to disconnect from network connectivity during generation of the recovery element encryption key cipher 560. Once the password encryption key cipher 520 and the recovery element encryption key cipher 560 are generated, the server 18 may discard or destroy the master encryption key 510, the password derived encryption key 420, and the recovery element derived encryption key 550. In this case, the transitory memory of the server 18 is further cleared in a manner that no artefacts of the master encryption key 510, the password derived encryption key 420, the recovery element derived encryption key 550, the recovery element 530, and the password 410 are recoverable from memory. As such and in one embodiment, the recovery element 530 is used to determine the recovery element derived encryption key 550 to decrypt the recovery element encryption key cipher 560 to obtain the master encryption key 510. In this regard, brute force attacks are prevented, as the brute force attacker must be able to execute and pass the recovery element-level user authentication to perform a brute force attack on the server 18.

FIG. 5C illustrates that the master encryption key 510 is encrypted via at least two independently usable encryption methodologies, each of which may be utilized independently to obtain the master encryption key through decryption. For example, the server 18 is configured to encrypt the master encryption key with a password-level of protection as depicted by Roman numeral I. and a recovery element-level of protection as depicted by Roman numeral II. In this regards, the master encryption key 510 is encrypted by the password derived encryption key 420 and the recovery element derived encryption key 550 to produce the password encryption key cipher 520 and the recovery element encryption key cipher 560 respectively. In this case the password 410 or the recovery element 530 may be used to determine the respective password derived encryption key 420 and the recovery element derived encryption key 550 which is used to decrypt the respective password encryption key cipher 520 and the recovery element encryption key cipher 560 to get back the master encryption key 510. As shown in FIG. 5C, the server 18 is configured to store the password encryption key cipher 520 and the recovery element encryption key cipher 560, illustrated by bold, solid lines. The server 18 does not store the password 410, the password derived encryption key 420, the master encryption key 510, the recovery element 530, and the recovery element derived encryption key 550. Not storing the master encryption key 510 on the server 18, the user computing device, and/or other entities may make it more difficult for an adversary to gain access to the master encryption key 510 and, as a result, may help to avoid certain security vulnerabilities.

In another example embodiment, the user computing entity 30 transmits a decryption request to the server 18 to decrypt the encrypted private data that may be stored on the server 18. For example, the server 18 may be configured to output a login interface to a display interface (i.e., a graphical user interface) of a user computing entity with at least options to encrypt or decrypt data. A user may login and choose to decrypt data by transmitting the decryption request. The decryption request includes a user identifier (e.g., user name, an internet protocol (IP) address, a media access control (MAC) address, and the like) and a password 410 as inputted by the user. Server 18 receives the user identifier and password 410, accesses the random salt value that corresponds to the user identifier, and utilizes the password 410 and the random salt value to determine the password derived encryption key 420 which is used to decrypt the master encryption key 510. Additionally or alternatively, the server 18 may require recovery element-level user authentication. In this case, the server 18 may be configured to output a recovery element interface to a display interface (i.e., a graphical user interface) of a user computing entity with at least options to select one or more recovery elements from a plurality of recovery elements each configured to trigger execution of recovery element-level user authentication. For example, the recovery element-level user authentication may include generating and sending a verification code to a user computing entity associated with the user. The verification code may be a PIN or a random string of upper and lower case characters, numbers, and special characters used to authenticate the user. In an example embodiment, the verification code is transmitted in an e-mail message to the user's email address. The user would then enter the verification code back in the recovery element interface. Upon determining a match between the generated verification code and the user-entered verification code, the server 18 utilizes the recovery element to determine the recovery element encryption key cipher to obtain the master encryption key. At this point the master encryption key is obtained by both the derived keys associated with the password and the recovery element. In some embodiments, the master encryption key is utilized by the server 18 to decrypt the encrypted private data. Using two key derivation functions (e.g., password derived encryption key and the recovery element derived encryption key) may make the master encryption key and private data less vulnerable to certain brute force attacks, dictionary attacks, and/or other potential threat vectors.

c. Password Reset Using a Recovery Element

FIG. 5D illustrates a process 500D of resetting a password using a recovery element 530. When a user forgets his/her password, the password utilized for encrypting the master encryption key 510 is reset, such that a new password is utilized to re-encrypt the master encryption key 510. A recovery element verification procedure as discussed above is provided to authenticate the user who requests to reset his/her password prior to setting a new password. In some embodiments, when the user requests a password reset (e.g., via a corresponding graphical user interface provided to the user's computing entity by the server 18), the server 18 sends a request for at least one recovery element. In some embodiments, the master encryption key may be encrypted using one or more recovery elements. In this case, the user using the user computing device may select at least one recovery element from a plurality of recovery elements. The at least one recovery element representing communication channel information for a user of the computing device may comprise a voice delivered passcode to a mobile or landline phone, a text delivered passcode to an email address, a text delivered passcode to a mobile phone via text messaging, a text delivered passcode to a third party social media account, or the like. In this regard, the server 18 may be configured to output a recovery element interface to a display interface (i.e., a graphical user interface) of a user computing entity with at least options to select one or more recovery elements from a plurality of recovery elements. For example, the server may present to the user, via the recovery element interface, the option to choose between a plurality of different recovery elements, such as email, mobile phone, landline phone, text messaging, or third party social media verification configured to trigger execution of recovery element-level user authentication (e.g., sending a verification code to a user computing entity associated with the user, such as by sending a verification code to the user's phone by text message, the user's email address, the user's third party social media application (e.g., Facebook®, LinkedIn®, Twitter), or the like and verifying this code before implementing the recovery element derivation function).

When the user selects email as the recovery element 530, the server 18 may provide a user interface to a user computing entity 30 (or may update an existing user interface previously provided to the user computing entity 30) requesting the user input his/her email address via the user interface. Upon verifying the recovery element, the server 18 may then generate a one-time passcode to be provided to the recovery element email address. The one-time passcode may be generated via any of a variety of mechanisms, such as through traditional random number generation, random character string generation, and/or the like. The one-time passcode may thus be embodied as a string, such as a numerical string, an alphanumerical string, and/or the like. After generation of the one-time passcode, the server 18 transmits the one-time passcode via the recovery element to the user, based on the information provided as user input providing the recovery element. The user receives the one-time passcode via account access associated with the recovery element (e.g., as an email when the recovery element is an email address, as a text message when the recovery element is a mobile phone number, as a message when the recovery element is a third party system, and/or the like). The server 18 additionally provides the user computing entity with a graphical user interface requesting user input indicative of the one-time passcode, thereby enabling the user to enter and submit the one-time passcode to the server 18 for verification to ensure the one-time passcode provided to the user's recovery element matches the one-time passcode the user entered, thereby demonstrating the user has access to the recovery element. Server 18 compares the one-time passcode received from the user against the one-time passcode transmitted to the user (or a hash thereof). Upon determining a match, the server 18 utilizes the recovery element 530 as shown in step 1 of FIG. 5D to determine the recovery element derived encryption key 550. The recovery element derived encryption key 550 is used to decrypt the recovery element encryption key cipher 560 in order to obtain the master encryption key 510, which may be stored in temporary memory to enable re-encryption thereof with a new password. Next, in step 2 of FIG. 5D, the server 18 may prompt the user, via the user interface, to enter a new password 570 which is used to generate a new password derived encryption key 572. The master encryption key 510 is re-encrypted with the new password derived encryption key 572 to produce a new password encryption key cipher 574. Further, the server 18 does not store the master encryption key 510, the recovery element derived encryption key 550, or the new password derived encryption key 572. The server may only store or have knowledge of the recovery element encryption key cipher 560 and the new password encryption key cipher 574.

In certain embodiments, the server 18 may utilize at least two recovery elements. In such embodiments, each of the at least two recovery elements may be utilized independently to decrypt the master encryption key. In other embodiments, a plurality of recovery elements may be utilized in combination (e.g., such that a concatenated combination of the plurality of recovery elements may be utilized to decrypt a recovery element encryption key cipher to decrypt the master encryption key). When utilizing a plurality of recovery elements in combination for decrypting the master encryption key, each of the recovery elements may be separately verified (e.g., via multi-factor authentication as discussed herein). Moreover, in certain embodiments at least one recovery element of the two recovery elements is associated with a cryptographic hash stored in a datastore of server 18. In certain embodiments, the server 18 may be configured for verification of user access to an account associated with a recovery element embodied as a third party system account by receiving data from the third party system. As just one example, a third party system may be embodied as a social media platform, and the server 18 may be configured to communicate with one or more computing entities associated with the social media platform (e.g., via an API) to obtain the user's social media user name (alternatively referred to herein as a social media identifier, such as a Facebook® account identifier). Server 18 may then store a cryptographic hash of the third party social media identifier. When a user loses his password for accessing the private data, the server 18 may implement a multi-factor authentication procedure in which the server requests (via data provided via a graphical user interface provided to the user computing entity) that the user login to his/her third party social media account. The graphical user interface presented to the user requesting login to the third party system may comprise a link to the third party system login page, and may additionally comprise an identifier within the link that provides data to the third party system requesting the third party system to transmit data to the server 18 (e.g., via an API). After successful logon, the third party social media identifier is sent from a user computing entity associated with the third party system to the server 18. The server 18 may then compare the third party social media identifier received with the stored cryptographic hash of the third party social media identifier. If the received third party social media identifier matches the stored cryptographic hash of the third party social media identifier, the server 18 prompts the user to enter a second recovery element via the third party social media platform. For example, the server 18 may provide a message to the user computing entity associated with the third party system that causes the third party system to display a graphical user interface to the user requesting entry of a second recovery element. For example, the server 18 (e.g., together with the third party system) may request that the user provide at least one of an email, mobile phone, landline phone, or text messaging contact information to be utilized as a recovery element. Once the user selects and inputs the second recovery element, data indicative of the second recovery element is provided to the server 18 (e.g., via an API), which may then generate and send a one-time passcode to the second recovery element provided by the user. The user receives the one-time passcode, and provides the same one-time passcode to the server 18 as discussed above. Server 18 compares the one-time passcode received from the user against the one-time passcode transmitted to the user (or a hash thereof). Upon determining a match, the server 18 utilizes the second recovery element as shown to calculate the second recovery element derived encryption key. The second recovery element derived encryption key is used to decrypt the stored second recovery element encryption key cipher in order to obtain the master encryption key. In this case, the server utilized at least two recovery elements to verify the user, wherein at least one of the two recovery elements is used to encrypt the master encryption key to generate a second recovery element encryption key cipher which is stored to the server 18. When more than one recovery element is used only one of them needs to be verified, e.g. by verifying a one-time use passcode.

d. Exemplary Process Flow for Encrypting the Master Encryption Key

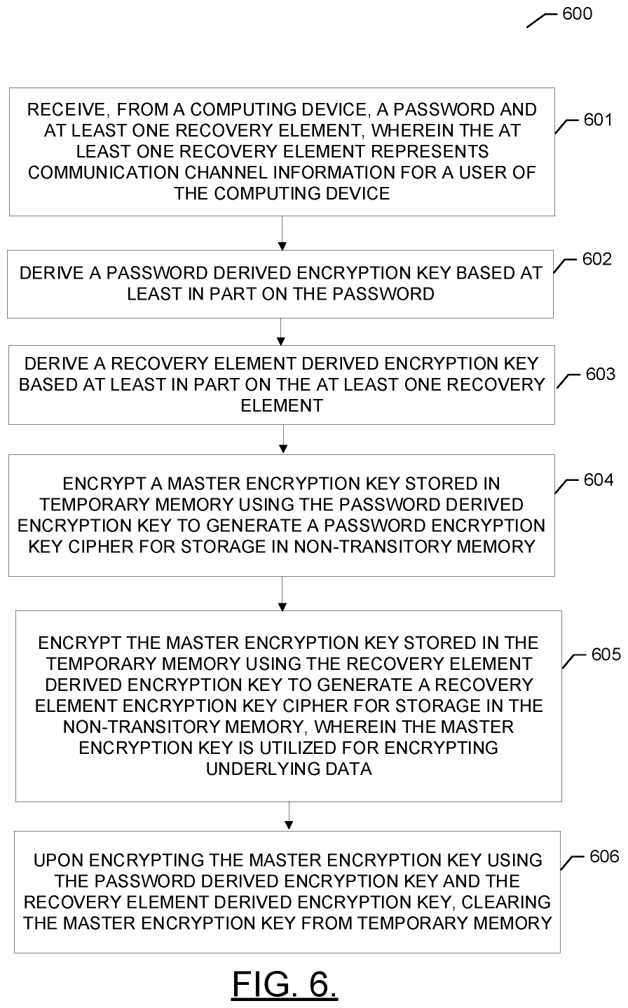

Prior to the exemplary process flow for encrypting the master encryption key depicted in FIG. 6, the master encryption key has already been created and the underlying private data has already been encrypted by the master encryption key. In such an instance, FIG. 6 illustrates a flow diagram for securing the master encryption key against unauthorized access. The method 600 illustrated in FIG. 6 includes computer-implemented method steps to receive, from a computing device, a password and at least one recovery element, wherein the at least one recovery element represents communication channel information for a user of the computing device as indicated at block 601. For example, the server 18 may be configured to output a login interface to a display interface (i.e., a graphical user interface) of a user computing entity with at least options to enter a password and select at least one recovery element. The password may be alphanumeric, graphical, spoken, etc. The at least one recovery element may be embodied as contact data for the user, such as an email address, a mobile phone number, third party social media application platform and corresponding username (e.g., Facebook®, LinkedIn®) or other authorization mechanisms in order to complete the process (e.g. email asking user to confirm server 18 generated passcode or confirm user). Server 18 receives the password and the at least one recovery element to derive a password derived encryption key based at least in part on the password (block 602) and derive a recovery element derived encryption key based at least in part on the at least one recovery element (block 603) according to key derivation functions described above. In block 604, the server 18 is configured to encrypt a master encryption key stored in temporary memory using the password derived encryption key to generate a password encryption key cipher for storage in non-transitory memory. In block 605, the server is further configured to encrypt the master encryption key stored in the temporary memory using the recovery element derived encryption key to generate a recovery element encryption key cipher for storage in the non-transitory memory, wherein the master encryption key is utilized for encrypting underlying data. In block 606, the server is further configured to, upon encrypting the master encryption key using the password derived encryption key and the recovery element derived encryption key, clear the master encryption key from temporary memory.

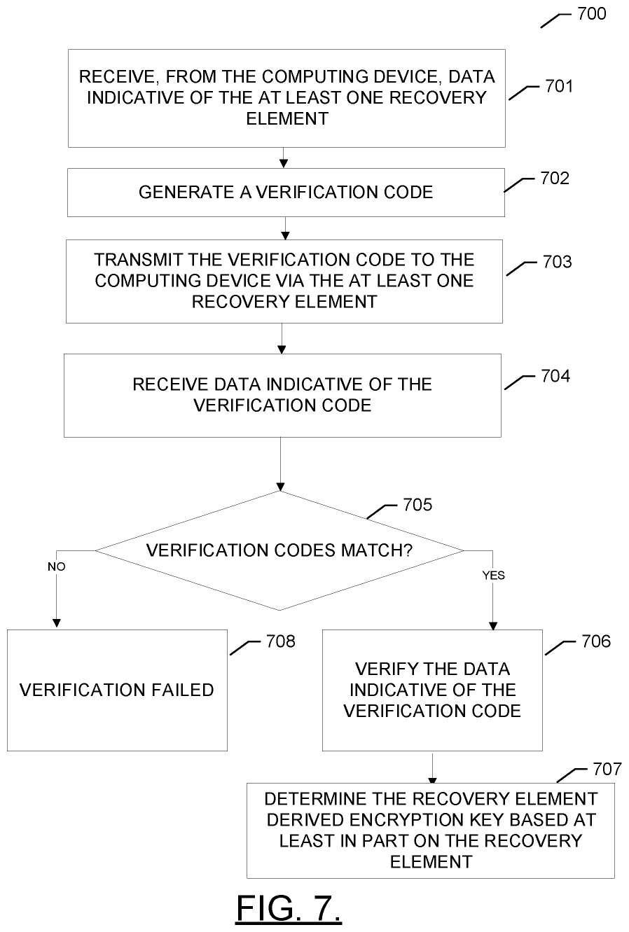

Prior to the exemplary process flow for verifying the at least one recovery element depicted in FIG. 7, the user, via the user computing device, has already determined at least one recovery element for user authentication. As shown in FIG. 7, block 701, the server 18 is configured to receive, from the computing device, data indicative of the at least one recovery element. The server 18 is then configured to utilize a verification instrument associated with the at least one recovery element to establish the user of the computing device as an authenticated user to the master encryption key. In embodiments, the verification instrument may include, but is not limited to, a token (e.g., acquired, by invoking an API, from a special-purpose client application (e.g., Facebook®, LinkedIn®, Twitter, WeChat, WhatsApp)) for the user, wherein after successful login the token indicates the user as an authenticated user. In this regard, the server 18 may verify the token generated by the special-purpose client application via an API call. For example, the server 18 may be configured to output a recovery element interface to a display interface (i.e., a graphical user interface) of a user computing entity with at least options to select one or more recovery elements. For example, in various embodiments, each of the plurality of recovery elements is configured to trigger execution of recovery element-level user authentication (e.g., utilizing a particular special-purpose client application API so that the server 18 can verify the token is valid). A valid token proving that the user has a successful login to the particular special-purpose client application. Upon the server 18 verifying the user as the authenticated user, the server 18 determines the recovery element derived encryption key based at least in part on the recovery element. In another example embodiment, the verification instrument may include a verification code. In such an instance, the server 18 may be configured to output a recovery element interface to a display interface (i.e., a graphical user interface) of a user computing entity with at least options to select one or more recovery elements. For example, in various embodiments, each of the plurality of recovery elements is configured to trigger execution of recovery element-level user authentication (e.g., sending a verification code to a user computing entity associated with the user, such as by sending a verification code to the user's phone by text message, the user's email address, the user's special-purpose client application (e.g., Facebook®, LinkedIn®, Twitter), or the like and verifying this code before authentication). In block 702, the server 18 is configured to generate a verification code. In block 704, the server 18 is configured to transmit the verification code to the computing device via the at least one recovery element. The server may then receive data indicative of the verification code as shown in block 704. In step 705, the server determines whether the verification codes match. If the server verifies the data indicative of the verification code as shown in block 706, the server 18 determines the recovery element derived encryption key based at least in part on the recovery element in block 707. If the server 18 determines that the verification codes do not match, a verification failure communication may be produced informing the user that the recovery element verification failed. In this case, the user may be prompted to re-enter the verification code up to a predetermined number of tries.

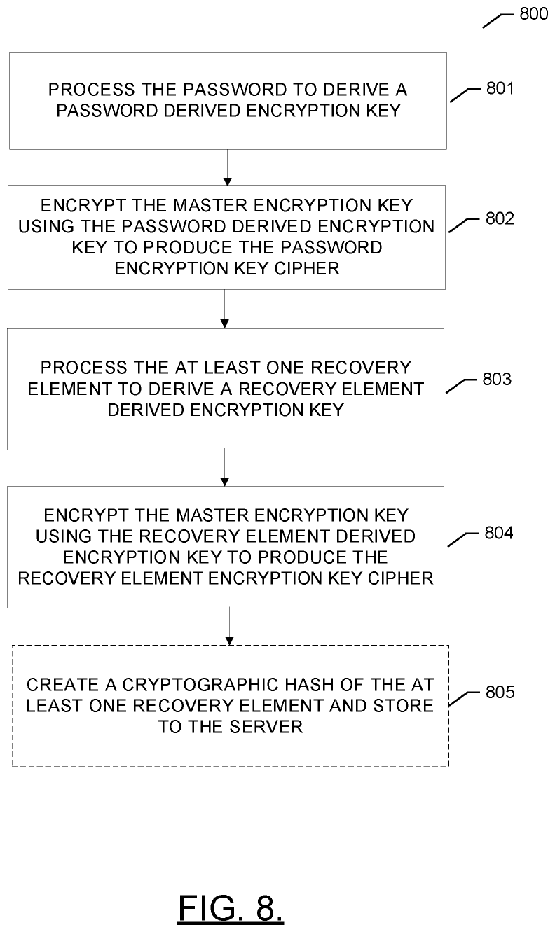

Prior to the exemplary process flow for encrypting the master encryption key with a password level of protection and a recovery element level of protection as in FIG. 8, the master encryption key has already been created and the underlying private data has already been encrypted by the master encryption key. In block 801, the server 18 processes the password to derive a password derived encryption key. In an example embodiment, the password is combined with a random salt value via PBKDF2 or other key derivation algorithm as described above. The server 18 includes hardware and/or software for implementing the PBKDF2 algorithm. PBKDF2 then yields a password derived encryption key. As shown in block 802, the server 18 is then configured to encrypt the master encryption key using the password derived encryption key to produce the password encryption key cipher.

In block 803, the server 18 processes the at least one recovery element to derive a recovery element derived encryption key. In an example embodiment, the recovery element is combined with a random salt value via PBKDF2 or other key derivation algorithm as described above. PBKDF2 then yields a recovery element derived encryption key. As shown in block 804, the server 18 is then configured to encrypt the master encryption key using the recovery element derived encryption key to produce the recovery element encryption key cipher.

In some embodiments, the server 18 is configured to create a cryptographic hash of the at least one recovery element and store to the server as depicted in block 805. For example, the server 18 may be configured to store a recovery element hash map which includes hash values computed for each of the recovery elements. In some embodiments, the hash values are computed by applying a cryptographic hash function to at least a portion (e.g., a content portion) of each of the recovery elements.

Returning to FIG. 6 and as shown in block 605, the server 18 is configured to store the password encryption key cipher and the recovery element encryption key cipher. In some embodiments the password encryption key cipher and the recovery element encryption key cipher may be used to recover the master encryption key used to decrypt data.

e. Exemplary Process Flow for Recovering the Master Encryption Key

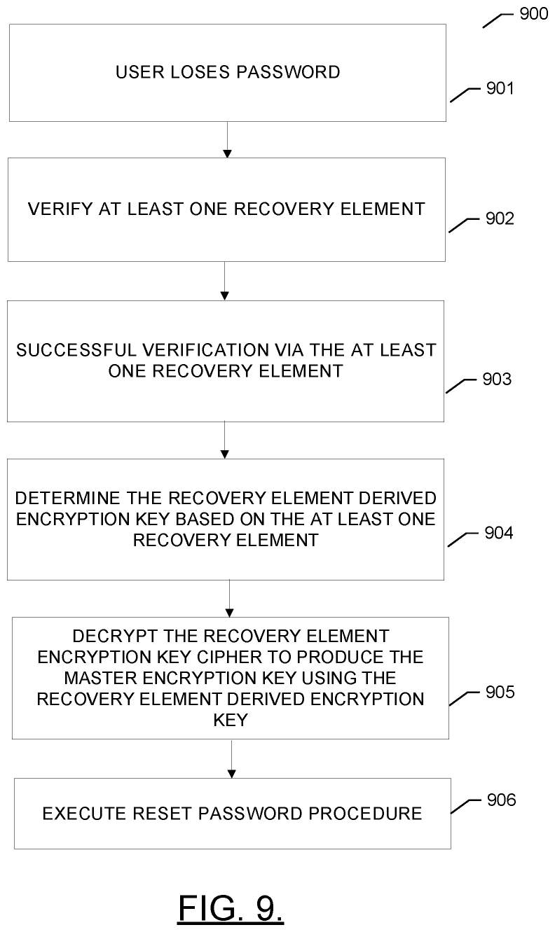

FIG. 9 illustrates a flow diagram of an example system for recovering the master encryption key when the user loses his/her password in accordance with some embodiments discussed herein. The method 900 illustrated in FIG. 9 begins with block 901 where the user loses his/her password. In some embodiments, the server 18 receives an indication that the user lost his/her password and requests verification via at least one recovery element. In this regard, the server 18 may be configured to output a lost password interface to a display interface of a user computing entity with at least an option to indicate to the server that the user has forgotten/lost their password.

In block 902, the server 18 is configured to verify the at least one recovery element, such as according to a method as illustrated in FIG. 7. In block 903, the server 18 confirms successful verification via the at least one recovery element and the operations continue with block 904 where the server determines the recovery element derived encryption key based on the at least one recovery element. For example, the server 18 retrieves the appropriate recovery element derived encryption key cipher (based on the user name as described above), and decrypts the recovery element encryption key cipher to produce the master encryption key using the recovery element derived encryption master encryption key as shown in block 905. Now that the master encryption key 510 is obtained, the server 18 may store the master encryption key (in temporary memory at the server, without access by the user) which is used to decrypt the encrypted private data. Additionally, the server may be configured to re-encrypt the master encryption key using anew password and/or another recovery element. In this case, the server may then execute the reset password procedure as depicted in block 906 and as further described in relation to FIG. 5D.

f. Exemplary Operations

In an example embodiment, an apparatus includes means, such as processing element 205, the communications interface 208, or the like for receiving, from a computing device, a password and at least one recovery element, wherein the at least one recovery element represents communication channel information for a user of the computing device. The apparatus of this example embodiment includes means, such as the processing element 205, the communications interface 208, or the like, for deriving a password derived encryption key based at least in part on the password, deriving a recovery element derived encryption key based at least in part on the at least one recovery element, encrypting a master encryption key stored in temporary memory using the password derived encryption key to generate a password encryption key cipher for storage in non-transitory memory, encrypting the master encryption key stored in the temporary memory using the recovery element derived encryption key to generate a recovery element encryption key cipher for storage in the non-transitory memory, wherein the master encryption key is utilized for encrypting underlying data and upon encrypting the master encryption key using the password derived encryption key and the recovery element derived encryption key, clearing the master encryption key from the temporary memory.

In some embodiments, the apparatus includes means, such as the processing element 205, the communications interface 208, or the like, for storing the password encryption key cipher and the recovery element encryption key cipher in association with a unique ID associated with the user. The at least one recovery element comprises at least one of: an email address, a mobile phone number, a landline phone number, a social media account identifier or a messaging application account identifier.

The apparatus of this example embodiment includes means, such as the processing element 205, the communications interface 208, or the like, for receiving, from the computing device, data indicative of the at least one recovery element, utilizing a verification instrument associated with the at least one recovery element to establish the user of the computing device as an authenticated user to the master encryption key, and upon verifying the user as the authenticated user, determining the recovery element derived encryption key based at least in part on the recovery element. In some embodiments, the apparatus includes means, such as the processing element 205, the communications interface 208, or the like, for determining the recovery element derived encryption key based on the at least one recovery element and decrypting the recovery element encryption key cipher to produce the master encryption key using the recovery element derived encryption key.

In some embodiments, the processing element 205, the communications interface 208, or the like, for determining the password derived encryption key based on the password and decrypting the password encryption key cipher to produce the master encryption key using the password derived encryption key. The apparatus of this example embodiment includes means, such as the processing element 205, the communications interface 208, or the like, for receiving, from the computing device, data indicative of the at least one recovery element and a user identifier, retrieving a corresponding recovery element encryption key cipher based at least in part on the user identifier, processing the at least one recovery element to derive the recovery element derived encryption key, decrypting the corresponding recovery element encryption key cipher to produce the master encryption key using the recovery element derived encryption key, and encrypting the master encryption key using a new password received from the computing device.

### V. Conclusion

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. (canceled)

2. A computer-implemented method comprising:
receiving, from a computing device, a password and at least one recovery element, wherein the at least one recovery element represents communication channel information for a user of the computing device;
deriving a password derived encryption key based at least in part on the password;
deriving a recovery element derived encryption key based at least in part on the at least one recovery element;
encrypting a master encryption key stored in temporary memory using the password derived encryption key to generate a password encryption key cipher for storage in non-transitory memory;
encrypting the master encryption key stored in the temporary memory using the recovery element derived encryption key to generate a recovery element encryption key cipher for storage in the non-transitory memory, wherein the master encryption key is utilized for encrypting underlying data; and
upon encrypting the master encryption key using the password derived encryption key and the recovery element derived encryption key, clearing the master encryption key from the temporary memory.

3. The computer-implemented method of claim 2, further comprising storing the password encryption key cipher and the recovery element encryption key cipher in association with a unique ID associated with the user.

4. The computer-implemented method of claim 2, wherein the at least one recovery element comprises at least one of: an email address, a mobile phone number, a landline phone number, a social media account identifier or a messaging application account identifier.

5. The computer-implemented method of claim 2, further comprising:
receiving, from the computing device, data indicative of the at least one recovery element;
utilizing a verification instrument associated with the at least one recovery element to establish the user of the computing device as an authenticated user to the master encryption key; and
upon verifying the user as the authenticated user, determining the recovery element derived encryption key based at least in part on the recovery element.

6. The computer-implemented method of claim 2, further comprising:
determining the recovery element derived encryption key based on the at least one recovery element; and
decrypting the recovery element encryption key cipher to produce the master encryption key using the recovery element derived encryption key.

7. The computer-implemented method of claim 2, further comprising:
determining the password derived encryption key based on the password; and
decrypting the password encryption key cipher to produce the master encryption key using the password derived encryption key.

8. The computer-implemented method of claim 2, further comprising:
receiving, from the computing device, data indicative of the at least one recovery element and a user identifier;
retrieving a corresponding recovery element encryption key cipher based at least in part on the user identifier;
processing the at least one recovery element to derive the recovery element derived encryption key;
decrypting the corresponding recovery element encryption key cipher to produce the master encryption key using the recovery element derived encryption key; and
encrypting the master encryption key using a new password received from the computing device.

9. An apparatus comprising:
at least one processor; and
at least one non-transitory memory storing instructions that, when executed by the processor, configure the apparatus to:
receive, from a computing device, a password and at least one recovery element, wherein the at least one recovery element represents communication channel information for a user of the computing device;
derive a password derived encryption key based at least in part on the password;
derive a recovery element derived encryption key based at least in part on the at least one recovery element;
encrypt a master encryption key stored in temporary memory using the password derived encryption key to generate a password encryption key cipher for storage in non-transitory memory;
encrypt the master encryption key stored in the temporary memory using the recovery element derived encryption key to generate a recovery element encryption key cipher for storage in the non-transitory memory, wherein the master encryption key is utilized for encrypting underlying data; and
upon encrypting the master encryption key using the password derived encryption key and the recovery element derived encryption key, clear the master encryption key from the temporary memory.

10. The apparatus of claim 9, wherein the at least one non-transitory memory stores instructions that, when executed by the processor, further configure the apparatus to:
store the password encryption key cipher and the recovery element encryption key cipher in association with a unique ID associated with the user.

11. The apparatus of claim 9, wherein the at least one recovery element comprises at least one of: an email address, a mobile phone number, a landline phone number, a social media account identifier or a messaging application account identifier.

12. The apparatus of claim 9, wherein the at least one non-transitory memory stores instructions that, when executed by the processor, further configure the apparatus to:
receive, from the computing device, data indicative of the at least one recovery element;
utilize a verification instrument associated with the at least one recovery element to establish the user of the computing device as an authenticated user to the master encryption key; and
upon verifying the user as the authenticated user, determine the recovery element derived encryption key based at least in part on the recovery element.

13. The apparatus of claim 9, wherein the at least one non-transitory memory stores instructions that, when executed by the processor, further configure the apparatus to:
determine the recovery element derived encryption key based on the at least one recovery element; and
decrypt the recovery element encryption key cipher to produce the master encryption key using the recovery element derived encryption key.

14. The apparatus of claim 9, wherein the at least one non-transitory memory stores instructions that, when executed by the processor, further configure the apparatus to:
determine the password derived encryption key based on the password; and
decrypt the password encryption key cipher to produce the master encryption key using the password derived encryption key.

15. The apparatus of claim 9, wherein the at least one non-transitory memory stores instructions that, when executed by the processor, further configure the apparatus to:
receive, from the computing device, data indicative of the at least one recovery element and a user identifier;
receive a corresponding recovery element encryption key cipher based at least in part on the user identifier;
process the at least one recovery element to derive the recovery element derived encryption key;
decrypt the corresponding recovery element encryption key cipher to produce the master encryption key using the recovery element derived encryption key; and
encrypt the master encryption key using a new password received from the computing device.

16. A computer program product comprising at least one non-transitory computer-readable storage medium having computer-executable program code instructions stored therein, the computer-executable program code instructions, in execution with a processor, configured to:
receive, from a computing device, a password and at least one recovery element, wherein the at least one recovery element represents communication channel information for a user of the computing device;
derive a password derived encryption key based at least in part on the password;
derive a recovery element derived encryption key based at least in part on the at least one recovery element;
encrypt a master encryption key stored in temporary memory using the password derived encryption key to generate a password encryption key cipher for storage in non-transitory memory;
encrypt the master encryption key stored in the temporary memory using the recovery element derived encryption key to generate a recovery element encryption key cipher for storage in the non-transitory memory, wherein the master encryption key is utilized for encrypting underlying data; and
upon encrypting the master encryption key using the password derived encryption key and the recovery element derived encryption key, clear the master encryption key from the temporary memory.

17. The computer program product of claim 16, wherein the computer-executable program code instructions, in execution with a processor, are further configured to:
store the password encryption key cipher and the recovery element encryption key cipher in association with a unique ID associated with the user.

18. The computer program product of claim 16, wherein the at least one recovery element comprises at least one of: an email address, a mobile phone number, a landline phone number, a social media account identifier or a messaging application account identifier.

19. The computer program product of claim 16, wherein the computer-executable program code instructions, in execution with a processor, are further configured to:
receive, from the computing device, data indicative of the at least one recovery element;
utilize a verification instrument associated with the at least one recovery element to establish the user of the computing device as an authenticated user to the master encryption key; and
upon verifying the user as the authenticated user, determine the recovery element derived encryption key based at least in part on the recovery element.

20. The computer program product of claim 16, wherein the computer-executable program code instructions, in execution with a processor, are further configured to:
determine the recovery element derived encryption key based on the at least one recovery element; and
decrypt the recovery element encryption key cipher to produce the master encryption key using the recovery element derived encryption key.

21. The computer program product of claim 16, wherein the computer-executable program code instructions, in execution with a processor, are further configured to:
determine the password derived encryption key based on the password; and
decrypt the password encryption key cipher to produce the master encryption key using the password derived encryption key.
